(19) United States
(12) Patent Application Publication
(10) Pub. No.: US 2026/0110898 A1
(43) Pub. Date: Apr. 23, 2026

(54) EXTENDED REALITY SYSTEM WITH ONE-DIMENSIONAL PUPIL EXPANSION PROJECTION LENS

(71) Applicant: NATIONAL CENTRAL UNIVERSITY, Taoyuan City (TW)

(72) Inventors: Wen-Hsin SUN, Taoyuan City (TW); Ying-Shun SHIU, Taoyuan City (TW); Guan-Wei HUANG, Taoyuan City (TW); Huai-Chih CHANG, Taoyuan City (TW); Wen-Kai LIN, Taoyuan City (TW); Ching-Cherng SUN, Taoyuan City (TW); Wei-Chia SU, Taoyuan City (TW)

(21) Appl. No.: 18/956,757

(22) Filed: Nov. 22, 2024

(30) Foreign Application Priority Data
Oct. 23, 2024 (TW) 113140262

(51) Int. Cl. G02B 27/00; G02B 27/01; G02B 27/09

(52) U.S. Cl. CPC G02B 27/0081; G02B 27/0172; G02B 27/0955; G02B 2027/0174

(57) ABSTRACT

An extended reality system with a one-dimensional pupil expansion projection lens. The extended reality system includes: a light guide element having a first light-coupling portion, a second light-coupling portion, and a light input portion; a first volume holographic element optically coupled to the first light-coupling portion; a second volume holographic element optically coupled to the second light-coupling portion; and a one-dimensional pupil expansion rectangular projection lens through which light is projected into the light input portion. The first volume holographic element and/or the second volume holographic element is provided with an optical grating for converting a one-dimensional image into a two-dimensional one. Compared with the prior art, the extended reality system features a decrease in system complexity and volume and an increase in viewing angle and light conversion efficiency.

### BACKGROUND OF THE INVENTION

### 1. Technical Field

The present invention relates to an extended reality system with a one-dimensional pupil expansion projection lens. More particularly, the invention relates to an extended reality system having a one-dimensional pupil expansion projection lens and configured to combine a real environment and a virtual environment with a man-machine interaction device.

### 2. Description of Related Art

Extended reality (XR) is an “umbrella” term referring generally to a technology whereby computer text or graphics are superposed on, or incorporated into, a real and/or virtual environment or whereby a real environment is combined with a virtual one. XR includes augmented reality (AR), virtual reality (VR), and mixed reality (MR). While the three “realities” have some common functions and requirements, each of them has distinct purposes and individual technical features.

Conventionally, an XR system is so configured that the image of a display device is projected into the XR system through a two-dimensional (2D) projection lens used in combination with four diffraction elements. The 2D projection lens and the diffraction elements, however, tend to cause such disadvantages to the XR system as high system complexity, bulkiness, a narrow viewing angle, and low light conversion efficiency.

### BRIEF SUMMARY OF THE INVENTION

The present invention provides an XR system having a one-dimensional pupil expansion projection lens. The invention is intended to solve such problems of the existing XR systems as high system complexity, bulkiness, a narrow viewing angle, and low light conversion efficiency, all of which are attributable to the fact that the existing XR systems can only be built on a 2D architecture.

The present invention provides an XR system that has a one-dimensional pupil expansion projection lens. More specifically, the XR system includes: a light guide element that has a first light-coupling portion, a second light-coupling portion, and a light input portion; a first volume holographic element that is provided at a position corresponding to the first light-coupling portion and is optically coupled to the first light-coupling portion; a second volume holographic element that is provided at a position corresponding to the second light-coupling portion and is optically coupled to the second light-coupling portion; and a one-dimensional pupil expansion rectangular projection lens that is provided at a position corresponding to where light is projected into the light input portion. The first volume holographic element and/or the second volume holographic element is provided with an optical grating for converting the one-dimensional image input through the light input portion into a two-dimensional image.

The present invention also provides a one-dimensional pupil expansion rectangular projection lens structure that includes: a lens housing that is rectangular, has a lens housing length, a lens housing width, and a lens housing height, and is formed with a lens-housing light input surface and a lens-housing light output surface; a first lens that has a first aspherical light input surface and a second aspherical light output surface, wherein the first aspherical light input surface is next to the lens-housing light input surface; an adhesively bonded lens assembly that has a second lens, a third lens, and a fourth lens, wherein the second lens has a third spherical light input surface optically coupled to the second aspherical light output surface, the third lens is joined to the second lens to form a fourth joined spherical surface, and the fourth lens is joined to the third lens to form a fifth joined spherical surface and has a sixth spherical light output surface; a fifth lens that has a seventh aspherical light input surface and an eighth aspherical light output surface, wherein the seventh aspherical light input surface is optically coupled to the sixth spherical light output surface; a sixth lens that has a ninth aspherical light input surface and a tenth aspherical light output surface, wherein the ninth aspherical light input surface is optically coupled to the eighth aspherical light output surface; and a seventh lens that has an eleventh aspherical light input surface and a twelfth aspherical light output surface, wherein the eleventh aspherical light input surface is optically coupled to the tenth aspherical light output surface, and the twelfth aspherical light output surface is next to the lens-housing light output surface.

### Implementation of the Present Invention can Produce at Least the Following Advantageous Effects:

1. A novel one-dimensional XR system is created.
2. A novel one-dimensional pupil expansion projection lens is provided.
3. The complexity of the XR system is effectively reduced in comparison with that of the prior art.
4. The volume and weight of the XR system are effectively reduced in comparison with those of the prior art.
5. The viewing angle of the XR system is effectively increased in comparison with that of the prior art.
6. The light conversion efficiency of the XR system is effectively improved in comparison with that of the prior art.
7. The use of four plastic aspherical lenses and a set of three adhesively bonded glass spherical lenses enables effective assembly and cost reduction.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein: FIG. 1 shows an embodiment of an XR system with a one-dimensional pupil expansion projection lens;

FIG. 2A shows an embodiment of a one-dimensional pupil expansion rectangular projection lens structure in a three-dimensional view;

FIG. 2B shows the three axial directions of the one-dimensional pupil expansion rectangular projection lens structure in FIG. 2A;

FIG. 3A shows the one-dimensional pupil expansion rectangular projection lens structure in FIG. 2A in a two-dimensional view, or more particularly along the Y-Z plane;

FIG. 3B shows the one-dimensional pupil expansion rectangular projection lens structure in FIG. 2A in another two-dimensional view, or more particularly along the X-Z plane;

FIG. 4 is a spot diagram of the one-dimensional pupil expansion rectangular projection lens structure in FIG. 2A;

FIG. 5 is a modulation transfer function (MTF) curve diagram of the one-dimensional pupil expansion rectangular projection lens structure in FIG. 2A;

FIG. 6 is a distortion diagram of the one-dimensional pupil expansion rectangular projection lens structure in FIG. 2A; and

FIG. 7 is a relative illumination diagram of the one-dimensional pupil expansion rectangular projection lens structure in FIG. 2A.

### DETAILED DESCRIPTION OF THE INVENTION

The present invention provides an XR system 100 that has a one-dimensional pupil expansion projection lens, and an embodiment of the XR system 100 is shown in FIG. 1. The XR system 100 includes a light guide element 10, a first volume holographic element 21, a second volume holographic element 22, and a one-dimensional pupil expansion rectangular projection lens 30.

The light guide element 10 has a first light-coupling portion 111, a second light-coupling portion 112, a light input portion 113, and a light output portion 114. The first volume holographic element 21 is provided at a position corresponding to the first light-coupling portion 111 and is optically coupled to the first light-coupling portion 111. The second volume holographic element 22 is provided at a position corresponding to the second light-coupling portion 112 and is optically coupled to the second light-coupling portion 112. The one-dimensional pupil expansion rectangular projection lens 30 is provided at a position corresponding to where light is projected into the light input portion 113.

During use, the image of a display device 40 is projected through the one-dimensional pupil expansion rectangular projection lens 30 into the light input portion 113 and then transmitted via the light guide element 10, the first volume holographic element 21, and the second volume holographic element 22, before being output through the light output portion 114 and eventually received by a human eye or an image-taking device 50.

The one-dimensional pupil expansion rectangular projection lens 30 can effectively reduce the volume and weight of the XR system 100 as a whole. In addition, the first volume holographic element 21 and/or the second volume holographic element 22 is provided with an optical grating for converting the image input through the light input portion 113 from one-dimensional to two-dimensional, so that the light output portion 114 can output a two-dimensional image to meet the two-dimensional vision/image requirement of the human eye or of the image-taking device 50.

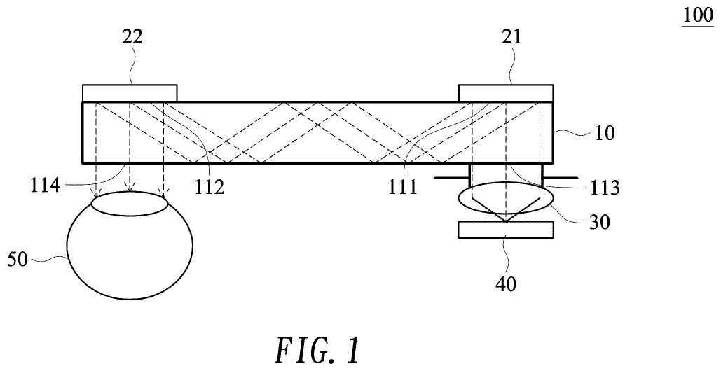

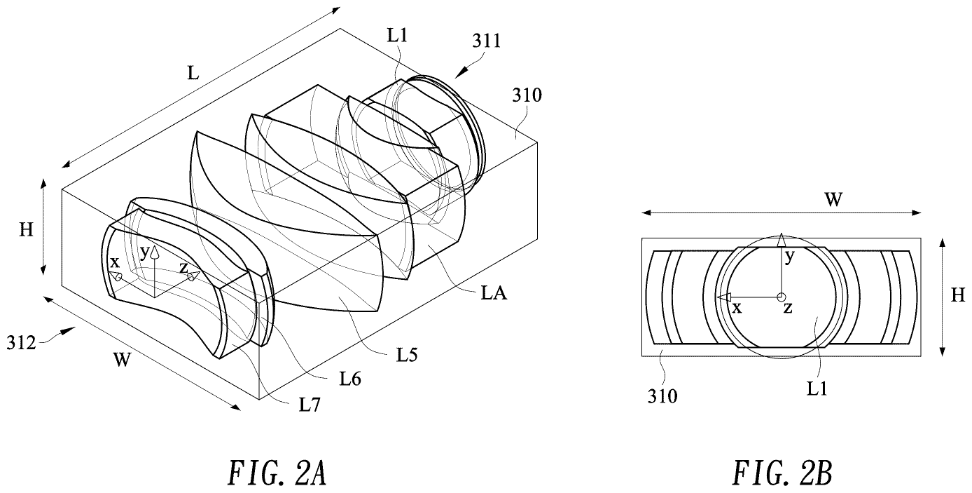

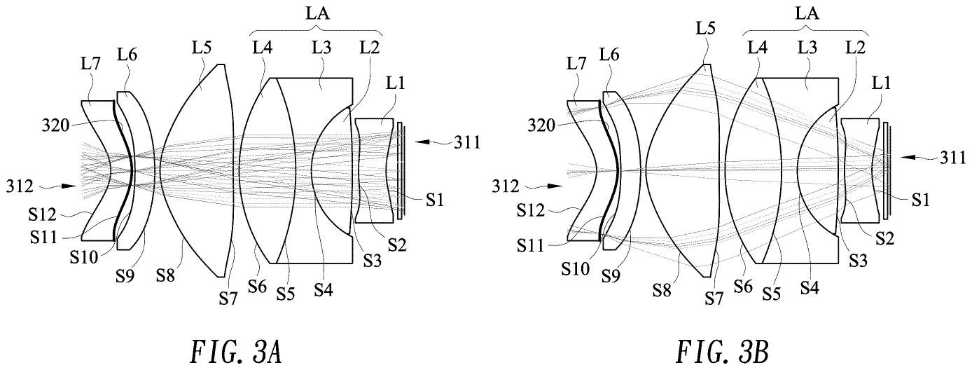

The present invention further provides a one-dimensional pupil expansion rectangular projection lens structure 30, an embodiment of which is shown in FIG. 2A to FIG. 3B. The one-dimensional pupil expansion rectangular projection lens structure 30 includes a lens housing 310, a first lens L1, an adhesively bonded lens assembly LA, a fifth lens L5, a sixth lens L6, and a seventh lens L7. The adhesively bonded lens assembly LA has a second lens L2, a third lens L3, and a fourth lens L4.

The lens housing 310 is the main supporting structure for the one-dimensional pupil expansion rectangular projection lens structure 30. The lens housing 310 is a rectangular hollow structure and has a lens housing length L, a lens housing width W, and a lens housing height H. The lens housing 310 is formed with a lens-housing light input surface 311 and a lens-housing light output surface 312. The lens housing width W is about 15-25 mm, the lens housing height H is about 4-8 mm, and the volume of the one-dimensional pupil expansion rectangular projection lens structure 30 is in the range from 14 cc to 18 cc.

The first lens L1 has a first aspherical light input surface S1 and a second aspherical light output surface S2. The first aspherical light input surface S1 is next to the lens-housing light input surface 311; in other words, the first lens L1 is provided at a position adjacent to the lens-housing light input surface 311.

The second lens L2 has a third spherical light input surface S3 optically coupled to the second aspherical light output surface S2; in other words, the third spherical light input surface S3 is provided at a position adjacent to the second aspherical light output surface S2.

The third lens L3 is joined to the second lens L2 to form a fourth joined spherical surface S4. For example, the third lens L3 and the second lens S2 are joined together by adhesive bonding in order to form the fourth joined spherical surface S4.

The fourth lens LA is joined to the third lens L3 to form a fifth joined spherical surface S5 and has a sixth spherical light output surface S6. For example, the fourth lens LA and the third lens S3 are joined together by adhesive bonding in order to form the fifth joined spherical surface S5.

The fifth lens L5 has a seventh aspherical light input surface S7 and an eighth aspherical light output surface S8. The seventh aspherical light input surface S7 is optically coupled to the sixth spherical light output surface S6; in other words, the seventh aspherical light input surface S7 is provided at a position adjacent to the sixth spherical light output surface S6.

The sixth lens L6 has a ninth aspherical light input surface S9 and a tenth aspherical light output surface S10. The ninth aspherical light input surface S9 is optically coupled to the eighth aspherical light output surface S8; in other words, the ninth aspherical light input surface S9 is provided at a position adjacent to the eighth aspherical light output surface S8.

The seventh lens L7 has an eleventh aspherical light input surface S11 and a twelfth aspherical light output surface S12. The eleventh aspherical light input surface S11 is optically coupled to the tenth aspherical light output surface S10. The twelfth aspherical light output surface S12 is next to the lens-housing light output surface 312; in other words, the seventh lens L7 is provided at a position adjacent to the lens-housing light output surface 312.

To filter out stray light effectively, a diaphragm 320 is provided on the eleventh aspherical light input surface S11, on the twelfth aspherical light output surface S12, on the lens-housing light output surface 312, or between the twelfth aspherical light output surface S12 and the lens-housing light output surface 312. The focal ratio of the diaphragm 320 may be in the range from 1.5 to 2.5.

Besides, the one-dimensional pupil expansion rectangular projection lens structure 30 has a viewing angle less than or equal to 50 degrees and a light conversion efficiency in the range from 5% to 10%.

To achieve optimal image quality, the first lens L1, the second lens L2, the third lens L3, the fourth lens LA, the fifth lens L5, the sixth lens L6, and the seventh lens L7 may have a negative, positive, negative, positive, positive, positive, and negative dioptric power respectively.

As far as production efficiency and cost are concerned, the first lens L1, the fifth lens L5, the sixth lens L6, and the seventh lens L7 may all be plastic lenses while the second lens L2, the third lens L3, and the fourth lens L4 are all glass lenses.

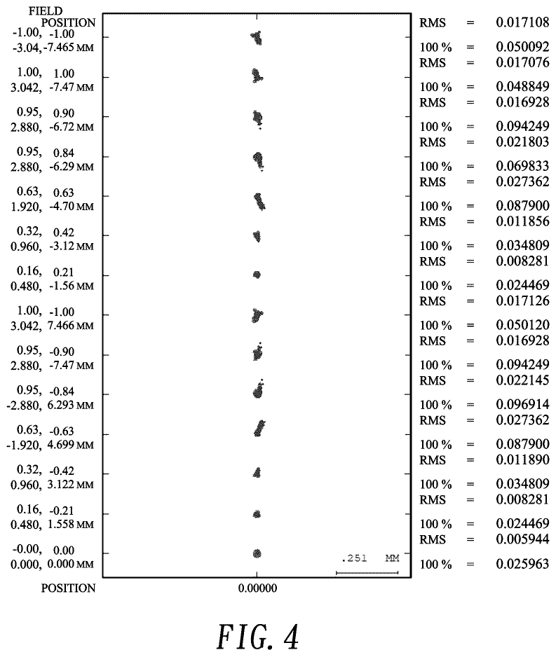

It can be seen in the spot diagram in FIG. 4 that the one-dimensional pupil expansion rectangular projection lens structure 30 has excellent focusing ability, or an excellent converging effect, in every field of view.

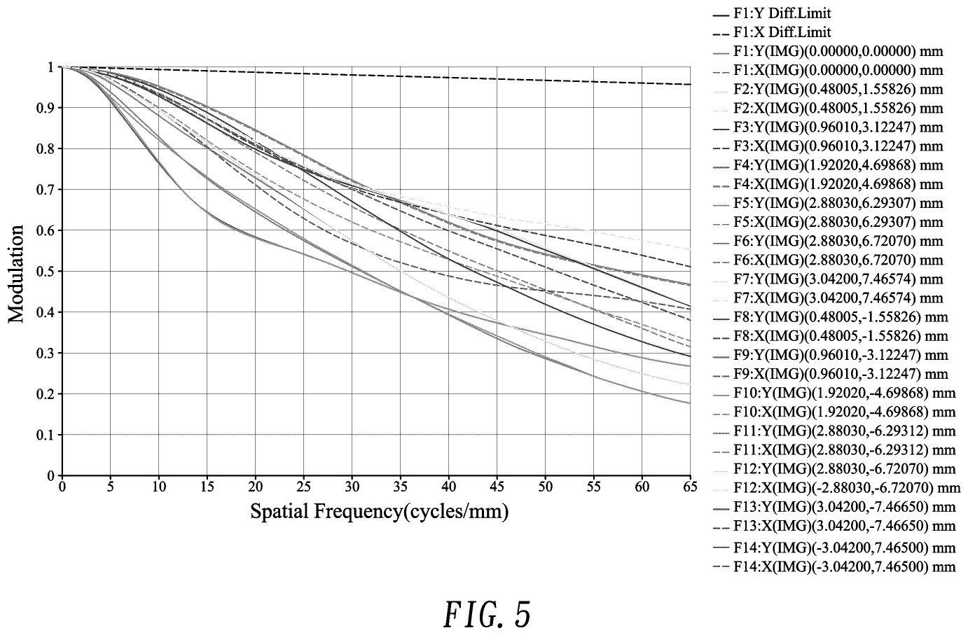

FIG. 5 shows a modulation transfer function (MTF) curve diagram in which F1-F14 represent adjacent fields of view each spanning 0.48005 degree, and in which the curves are divided into tangential (X)-direction curves and radial (Y)-direction curves. It can be seen in the diagram that the modulation is greater than or equal to 0.177 when the spatial frequency is less than or equal to 65 cycles/mm.

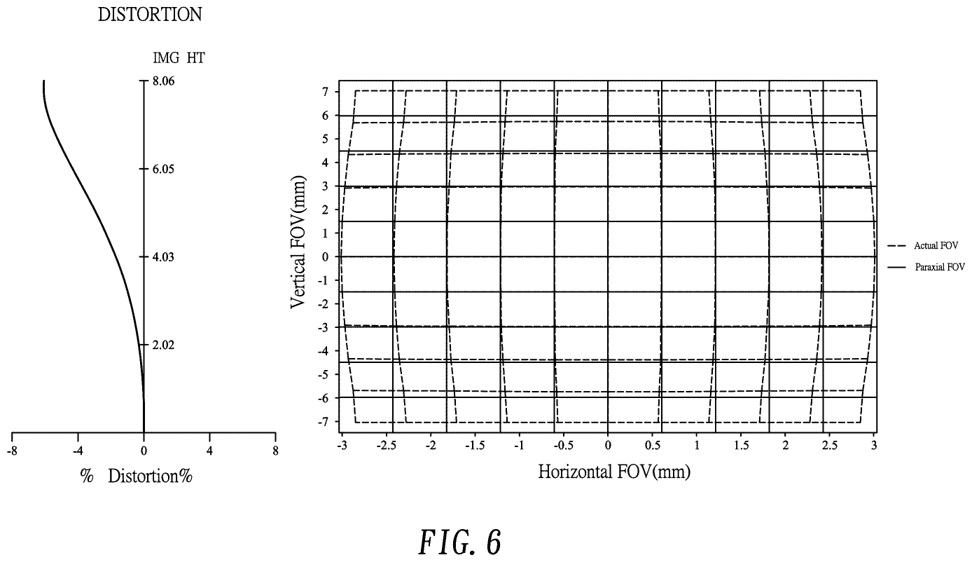

In addition, it can be seen in the distortion diagram in FIG. 6 that when the image half-height (IMG HT) on the display panel is less than or equal to 8.06 mm, the absolute value of optical distortion is less than or equal to 6.02% (i.e., |optical distortion|≤6.02%).

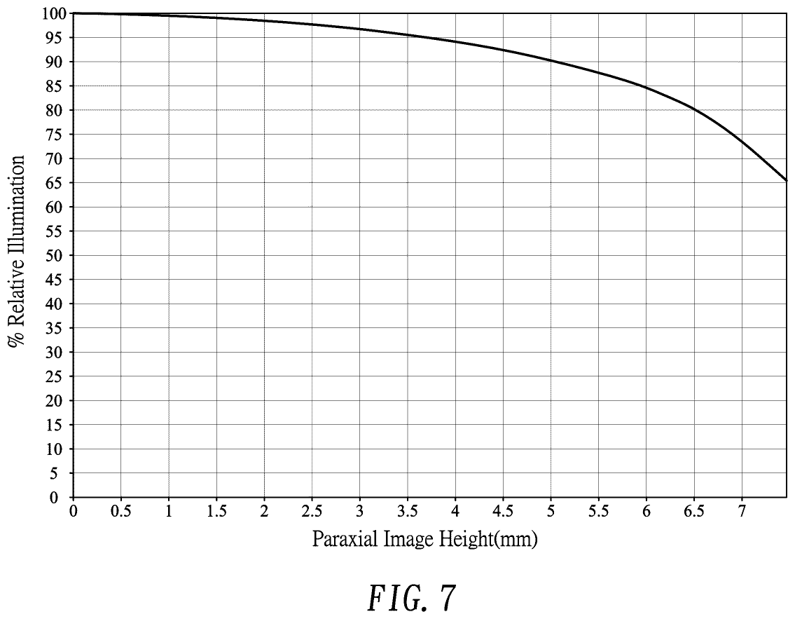

Furthermore, the relative illumination diagram in FIG. 7 shows that the relative illumination (RI) of the one-dimensional pupil expansion rectangular projection lens structure 30 is at least 65% at a one-sided paraxial image height of 0-7.5 mm.

The foregoing XR system 100 with a one-dimensional pupil expansion projection lens is so designed that after diffraction by the first volume holographic element 21 and the second volume holographic element 22, the light conversion efficiency is about 5%-10%. By contrast, a conventional two-dimensional pupil expansion XR system requires four diffraction elements, and given that diffraction by each diffraction element reduces optical efficiency to about 30%, the light conversion efficiency is only about 1%. Therefore, the XR system 100 with a one-dimensional pupil expansion projection lens provides an about 10-fold improvement in light conversion efficiency.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. An extended reality system with a one-dimensional pupil expansion projection lens, comprising:
a light guide element having a first light-coupling portion, a second light-coupling portion, and a light input portion;
a first volume holographic element provided at a position corresponding to the first light-coupling portion, wherein the first volume holographic element is optically coupled to the first light-coupling portion;
a second volume holographic element provided at a position corresponding to the second light-coupling portion, wherein the second volume holographic element is optically coupled to the second light-coupling portion; and
a one-dimensional pupil expansion rectangular projection lens provided at a position corresponding to where light is projected into the light input portion;
wherein the first volume holographic element and/or the second volume holographic element is provided with an optical grating for converting a one-dimensional image input through the light input portion into a two-dimensional image.

2. The extended reality system with a one-dimensional pupil expansion projection lens of claim 1, wherein the one-dimensional pupil expansion rectangular projection lens, comprising:
a lens housing having a rectangular shape, a lens housing length, a lens housing width, and a lens housing height and formed with a lens-housing light input surface and a lens-housing light output surface;
a first lens having a first aspherical light input surface and a second aspherical light output surface, wherein the first aspherical light input surface is next to the lens-housing light input surface;
an adhesively bonded lens assembly having:
a second lens having a third spherical light input surface optically coupled to the second aspherical light output surface;
a third lens joined to the second lens to form a fourth joined spherical surface; and
a fourth lens joined to the third lens to form a fifth joined spherical surface, wherein the fourth lens has a sixth spherical light output surface;
a fifth lens having a seventh aspherical light input surface and an eighth aspherical light output surface, wherein the seventh aspherical light input surface is optically coupled to the sixth spherical light output surface;
a sixth lens having a ninth aspherical light input surface and a tenth aspherical light output surface, wherein the ninth aspherical light input surface is optically coupled to the eighth aspherical light output surface; and
a seventh lens having an eleventh aspherical light input surface and a twelfth aspherical light output surface, wherein the eleventh aspherical light input surface is optically coupled to the tenth aspherical light output surface, and the twelfth aspherical light output surface is next to the lens-housing light output surface.

3. The extended reality system with a one-dimensional pupil expansion projection lens of claim 2, wherein the lens housing width is 15-25 mm, and the lens housing height is 4-8 mm.

4. The extended reality system with a one-dimensional pupil expansion projection lens of claim 2, wherein the one-dimensional pupil expansion rectangular projection lens structure has a volume in a range from 14 cc to 18 cc.

5. The extended reality system with a one-dimensional pupil expansion projection lens of claim 2, wherein the one-dimensional pupil expansion rectangular projection lens structure has a viewing angle less than or equal to 50 degrees.

6. The extended reality system with a one-dimensional pupil expansion projection lens of claim 2, wherein the one-dimensional pupil expansion rectangular projection lens structure has a light conversion efficiency in a range from 5% to 10%.

7. The extended reality system with a one-dimensional pupil expansion projection lens of claim 2, further comprising a diaphragm provided on the eleventh aspherical light input surface, on the twelfth aspherical light output surface, on the lens-housing light output surface, or between the twelfth aspherical light output surface and the lens-housing light output surface.

8. The extended reality system with a one-dimensional pupil expansion projection lens of claim 7, wherein the diaphragm has a focal ratio in a range from 1.5 to 2.5.

9. The extended reality system with a one-dimensional pupil expansion projection lens of claim 2, wherein the first lens, the second lens, the third lens, the fourth lens, the fifth lens, the sixth lens, and the seventh lens have a negative, positive, negative, positive, positive, positive, and negative dioptric power respectively.

10. The extended reality system with a one-dimensional pupil expansion projection lens of claim 2, wherein the first lens, the fifth lens, the sixth lens, and the seventh lens are plastic lenses, and the second lens, the third lens, and the fourth lens are glass lenses.
